(19) United States
(12) Patent Application Publication
(10) Pub. No.: US 2006/0188345 A1
(43) Pub. Date: Aug. 24, 2006

(54) Rotary cutting tool with pairs of helical cutting edges having different helix angles

(76) Inventors: Mark L. Greenwood, Hartland, WI (US); Kevin Cranker, Dousman, WI (US)

Correspondence Address: LAW OFFICES OF ERIC KARICH, 2807 ST. MARK DR., MANSFIELD, TX, 76063, US

(21) Appl. No.: 11/110,054

(22) Filed: Apr. 20, 2005

Related U.S. Application Data
(60) Provisional application No. 60/654,541, filed on Feb. 18, 2005.

(51) Int. Cl. B23C 5/10

(52) U.S. Cl. 407/54

(57) ABSTRACT

A rotary cutting tool is disclosed including a substantially cylindrical main body having a shank portion at one end and a point at an opposite end. A first pair of flutes formed on opposite sides of the main body extend continuously from the point to the shank portion, wherein each of the first pair of flutes defines a helical cutting edge having a helix angle of about 37 degrees with respect to an axis of the main body. A second pair of flutes formed on opposite sides of the main body and extend continuously from the point to the shank portion, wherein each of the second pair of flutes defines a helical cutting edge having a helix angle of approximately 33 degrees with respect to the axis of the main body. The first and second pairs of flutes are interleaved.

### CROSS-REFERENCE TO RELATED APPLICATIONS

This application for a utility patent claims the benefit of U.S. Provisional Application No. 60/654,541, filed Feb. 18, 2005.

### STATEMENT REGARDING FEDERALLY SPONSORED RESEARCH

Not Applicable

### BACKGROUND OF THE INVENTION

1. Field of the Invention

This invention relates generally to rotary cutting tools and end mills, and more particularly to helically fluted end mills having variable helical angles for improved performance characteristics.

2. Description of Related Art

Rotary cutting tools are used for various machining operations on workpieces. An end mill cutter or “end mill” is a type of rotary cutting tool. Machine operations often carried out using an end mill cutter include the forming of slots, keyways, and pockets. During typical use of an end mill cutter, a milling machine rotatably drives the end mill cutter about its longitudinal axis, and various cutting edges of the end mill cutter are used to remove material from a workpiece.

Over time, the cutting edges of an end mill cutter become dull due to physical contact between the end mill cutter and workpieces. As the cutting edges become dull, internal stresses generated within the end mill cutter during use increase. Harmonic vibrations constitute major sources of internal stresses in end mill cutters. It is common for end mill cutters to break during use due to the internal stresses. One way of extending the operation life of a end mill cutter is to reduce the amplitudes of harmonic vibrations generated within the tool during use.

It would thus be beneficial to have an end mill cutter wherein amplitudes of harmonic vibrations generated within the tool during use are reduced. The operational life of such an end mill cutter would expectedly be extended significantly.

The state of the art includes the following:

Flynn, et al, U.S. 2003/0118411 A1, teaches an end mill that include a flute having a helix which varies along the length of the tool. The end mill may include varying numbers of flutes, whether odd or even; helix change(s) within a flute or between flutes; or indexing between cutting edges or flutes. A ‘slow’ or ‘high’ helix may be used at the end or starting point of the tool, depending upon the application. A slow helix at the end or starting point is desirable for a strong corner in ramping and plunging into the material. When a higher helix is used at the end transitioning to a smaller helix at the shank, the corner is also protected because of the helix change. The high helix at the tip may be needed for shearing action in a given material.

Risen, Jr., U.S. Pat. No. 6,652,203 B1, teaches a precision drill bit that includes at least one cutting flute extends along the length of the bit and exhibits a helix angle of about 38.degree. at the tip. The helix angle decreases to an angle of about 15.degree. at the end of the flute run-out. The helix angle changes progressively and substantially linearly over a number of segments along the length of the drill bit.

Ito, U.S. 2003/0185640 A1, teaches a dual rake twist drill bit for drilling holes in articles made of abrasive materials (fiberglass-filled printed circuit boards, which relatively quickly dull bits). The bit includes spiraled flutes with cutting lips and inclined to the axis of the bit at a relatively small helix angle or rake in the range of about 3 degrees to 10 degrees. A longer rear portion which the flutes and cutting lips have a larger rake of about 33 degrees. The dual rake bit has substantially greater wear resistance than single rake bits. In a modification of the dual rake bit, the central web portion has a front longitudinal portion which is relatively acutely tapered, and a rear portion which is relatively modestly tapered, the dual tapered construction increasing resistance of the bit to breaking.

Noland, U.S. 2004/0120777 A1, teaches a rotary cutting tool that includes a plurality of axial flutes extends from an end surface to a fluted cutting end and combines with a plurality of cutting edges. The cutting edges are unequally spaced along the circumference of the end surface lying in a plane perpendicular to the longitudinal axis of rotation. In addition, all cutting edges are of a different helix from one another and the cutting edge geometries vary from one another to create a different sound pattern that reduces resonant harmonic vibrations.

Walrath, U.S. 2004/0057803 A1 and U.S. 2004/0258490, teach a rotary end-mill having a deferential flute construction with all individual flutes being unequally spaced about the circumference of the cylindrical tool body at different helix angles. The cutting edge of these flutes also face in the direction of tool rotation.

Other references of interest include the following: C. O. Graves, U.S. Pat. No. 2,782,490; H. P. Brumell, et al, U.S. Pat. No. 1,963,611; Kuberski, U.S. Pat. No. 5,779,399; George, U.S. Pat. No. D445,436 S; Kouvelis, U.S. Pat. No. Des. 430,584 and Nishimura, U.S. Pat. No. Des. 328,557.

All of the above-described references are hereby incorporated by reference in full.

### SUMMARY OF THE INVENTION

A rotary cutting tool is disclosed including a substantially cylindrical main body having a shank portion at one end and a point at an opposite end. A first pair of flutes formed on opposite sides of the main body extend continuously from the point to the shank portion, wherein each of the first pair of flutes defines a helical cutting edge having a helix angle of about 37 degrees with respect to an axis of the main body. A second pair of flutes formed on opposite sides of the main body and extend continuously from the point to the shank portion, wherein each of the second pair of flutes defines a helical cutting edge having a helix angle of approximately 33 degrees with respect to the axis of the main body. The first and second pairs of flutes are interleaved.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a side elevation view of one embodiment of a rotary cutting tool including a substantially cylindrical main body having a point at one end; and

FIG. 2 is an end view of the rotary cutting tool of FIG. 1 illustrating features of the point of the main body.

### DETAILED DESCRIPTION OF THE INVENTION

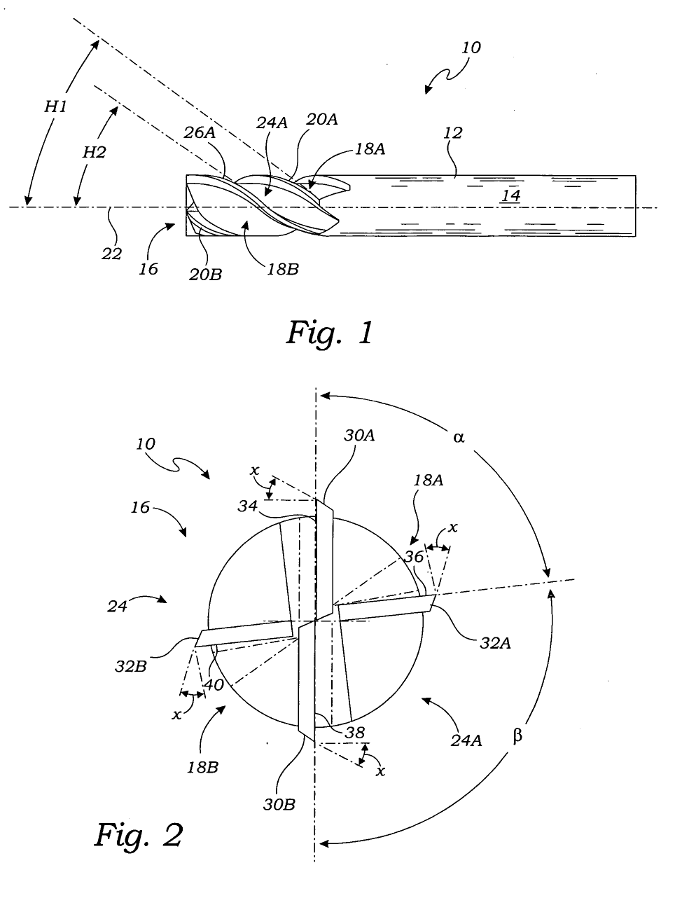

FIG. 1 is a side elevation view of one embodiment of a rotary cutting tool 10 including a substantially cylindrical main body 12 having a shank portion 14 at one end and a point 16 at an opposite end. In the embodiment of FIG. 1, the rotary cutting tool 10 is an end milling cutter or “end mill,” and has two pairs of flutes. The two pairs of flutes are interleaved about an outer surface of the main body 12. That is, members of the two pairs of flutes alternate about the outer surface of the main body 12.

In FIG. 1, a first pair of the 4 flutes of the rotary cutting tool 10 are labeled 18A and 18B. The flute 18A extends continuously from the point 16 to the shank portion 14, and defines a helical cutting edge 20A about the outer surface of the main body 12. The flute 18B is formed on an opposite side of the main body 12, extends continuously from the point 16 to the shank portion 14, and defines a helical cutting edge 20B about the outer surface of the main body 12. As indicated in FIG. 1, the helical cutting edge 20A has a helix angle “H1” with respect to an axis 22 of the substantially cylindrical main body 12 and a tangent line of the helical cutting edge 20A. The helix angle H1 also exists between the helical cutting edge 20B and the axis 22 of the main body 12.

One of the second pair of the flutes is visible in FIG. 1, and is labeled 24A. The flute 24A extends continuously from the point 16 to the shank portion 14, and defines a helical cutting edge 26A about the outer surface of the main body 12. As shown in FIG. 1, the flute 24A is positioned between the flutes 18A and 18B of the first pair of flutes. The other flute of the second pair of flutes (labeled 24B in FIG. 2) is positioned on an opposite side of the main body 12, and is also between the flutes 18A and 18B of the first pair of flutes. As indicated in FIG. 1, the helical cutting edge 26A defined by the flute 24A has a helix angle “H2” with respect to the axis 22 of the substantially cylindrical main body 12 and a tangent line of the helical cutting edge 26A. A helical cutting edge defined by the other flute of the second pair of flutes also has the helix angle H2 with respect to the axis 22 of the substantially cylindrical main body 12.

In a preferred embodiment, the helix angle H1 is about 37 degrees, and the helix angle H2 is about 33 degrees. Alternating helical cutting edges with these helix angles have been found to substantially extend the operational life of the rotary cutting tool 10. It is believed that these helix angles serve to reduce amplitudes of harmonic vibrations generated within the rotary cutting tool 10 during use, thereby substantially extending the operational life of the rotary cutting tool 10. For purposes of this application, the term “about 37 degrees” shall be defined to mean 37+/−1.5 degrees, and the term “about 33 degrees” shall be defined to mean 33+/−1.5 degrees. In the most preferred embodiment, these terms shall include 37+/−0.8 degrees and 33+/−0.8 degrees.

While the preferred embodiment includes flutes that have a constant helical angles along the length of the flute, in some embodiments this angle may be varied along the length of the flute. To the extent that such variation is made by one skilled in the art to significantly copy the above-described geometries and without impeding the performance of the tool, such variation should be considered equivalent to the embodiment described and within the scope of the invention, as claimed.

FIG. 2 is an end view of the rotary cutting tool 10 of FIG. 1 illustrating features of the point 16 of the main body 12. As shown in FIG. 2, the rotary cutting tool 10 has two pairs of flat cutting edges at the point 16. The two pairs of flat cutting edges are interleaved about the point 16. That is, members of the two pairs of flat cutting edges alternate about the point 16.

In FIG. 2, a first pair of the flat cutting edges are labeled 30A and 30B. The flat cutting edges 30A and 30B are positioned on opposite sides of the main body 12 at the point 16. The flute 18A extends continuously from the flat cutting edge 30A to the shank portion 14 of the main body 12 (see FIG. 1), and the flute 18B extends continuously from the flat cutting edge 30B to the shank portion 14 of the main body 12.

The second pair of the flat cutting edges are labeled 32A and 32B. Like the cutting edges 30A and 30B, the flat cutting edges 32A and 32B are positioned on opposite sides of the main body 12 at the point 16. The flute 24A extends continuously from the flat cutting edge 32A to the shank portion 14 of the main body 12 (see FIG. 1), and the flute 24B extends continuously from the flat cutting edge 32B to the shank portion 14 of the main body 12.

As indicated is FIG. 2, the two pairs of flat cutting edges are arranged such that an angle “α” exists between a leading edge 34 of the flat cutting edge 30A and a leading edge 36 of the adjacent flat cutting edge 32A. The angle α also exists between a leading edge 38 of the flat cutting edge 30B and a leading edge 40 of the adjacent flat cutting edge 32B. An angle “β” exists between the leading edge 36 of the flat cutting edge 32A and the leading edge 38 of the adjacent flat cutting edge 30B, and between the leading edge 40 of the flat cutting edge 32B and the leading edge 34 of the adjacent flat cutting edge 30A.

In the preferred embodiment, the angle α is of about 83.5 degrees, and the angle β is about 96.5 degrees.

As indicated is FIG. 2, an angle “x” exists between the leading edge 34 and an opposed trailing edge of the flat cutting edge 30A at an outer of the flat cutting edge 30A. The angle x also exists between the leading edges and the opposed trailing edges of the flat cutting edges 30B, 32A, and 32B at outer of the respective flat cutting edges 30B, 32A, and 32B. In the preferred embodiment, the angle x is about 9 degrees.

The rotary cutting tool 10 of FIGS. 1-2 is preferably made from at least one metal. Suitable metals and metal alloys include steel (including high speed steel and stainless steel), cast iron, carbide (an alloy including cobalt and tungsten), and titanium. A portion of the rotary cutting tool 10 including the 4 flat cutting edges 30A, 30B, 32A, and 32B, and the 4 helical cutting edges (including the helical cutting edges 20A, 20B, and 26A) is preferably coated with a wear reducing material. Suitable wear reducing materials include titanium nitride (TiN), titanium aluminum nitride (TiAlN), titanium carbonitride (TiCN), zirconium nitride (ZrN), and aluminum titanium nitride (AlTiN).

Three separate tests were conducted over several months to compare the operational effectiveness of the rotary cutting tool 10 of FIGS. 1-2 to other commonly used and commercially available end mill cutters. In each of these tests, the operational life of the rotary cutting tool 10 exceeded the operational lives of the other end mill cutters. It is believed that the helix angles used in the rotary cutting tool 10 and described above reduced amplitudes of harmonic vibrations generated within the rotary cutting tool 10 during use, thereby substantially extending the operational life of the rotary cutting tool 10. In each test, the greater operational life of the rotary cutting tool 10 represented a significant savings in both operating time and operating cost.

A first operation test of the rotary cutting tool 10 of FIGS. 1-2 was conducted on May 18, 2004. In the first operational test, an end mill cutter manufactured by Sumitomo Electric Carbide, Inc. (a division of Sumitomo Electric Industries, Ltd., Osaka, Japan), model number SSI432C, and the rotary cutting tool 10, were operated similarly to perform similar milling operations on similar materials. The Sumitomo Electric Carbide cutter is made from Carbide, has 4 flutes each defining a helical cutting edge having a helix angle of 30 degrees, and has a coating of ZX super Lattice. The rotary cutting tool 10 was formed from H10F Carbide, and was coated with titanium aluminum nitride (TiAlN). During the first operational test, the Sumitomo Electric Carbide end mill cutter produced 140 pieces per edge, and the rotary cutting tool 10 produced 440 pieces per edge. The tool life per edge per minute was 105 for the Sumitomo Electric Carbide end mill cutter, and 330 for the rotary cutting tool 10.

A second operation test of the rotary cutting tool 10 of FIGS. 1-2 was conducted on Aug. 18, 2004. In the second operational test, an end mill cutter manufactured by T. J. Grinding, Inc. (Waukesha, Wis.), model number MFG, and the rotary cutting tool 10, were operated similarly to perform similar milling operations on similar materials. The T. J. Grinding cutter is made from Carbide, has 4 flutes each defining a helical cutting edge having a helix angle of 30 degrees, and has a coating of zirconium nitride (ZrN). The rotary cutting tool 10 was formed from H10F Carbide, and was coated with titanium aluminum nitride (TiAlN). During second operational test, the T. J. Grinding end mill cutter produced 12 [pieces per edge], and the rotary cutting tool 10 produced 27 pieces per edge. The tool life per edge per minute was 29 for the T. J. Grinding end mill cutter, and 65 for the rotary cutting tool 10.

The third operation test of the rotary cutting tool 10 of FIGS. 1-2 was conducted on Dec. 15, 2004. In the third operational test, an end mill cutter manufactured by the YG-1 Tool Company (Vernon Hills, Ill.), model number 83593TE, and the rotary cutting tool 10, were operated similarly to perform similar milling operations on similar materials. The YG-1 Tool Company model number 83593TE has 3 flutes, each defining a helical cutting edge having a helix angle of 50 degrees, and is coated with titanium aluminum nitride (TiAlN). The rotary cutting tool 10 was formed from X Power Carbide, and was also coated with titanium aluminum nitride (TiAlN). During third operational test, the YG-1 Tool Company end mill cutter produced 400 pieces per edge, and the rotary cutting tool 10 produced 2,800 pieces per edge. The tool life per edge per minute was 356 for the YG-1 Tool Company, and 1,876 for the rotary cutting tool 10.

As illustrated by the above-described tests, the geometries provided in the present invention provide a significant improvement in wear life of the cutting tool, and represent a significant advance in the state of the art.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A rotary cutting tool, comprising:
a substantially cylindrical main body having a shank portion at one end and a point at an opposite end;
a first pair of flutes formed on opposite sides of the main body and extending continuously from the point to the shank portion, wherein each of the first pair of flutes defines a helical cutting edge having a helix angle of about 37 degrees with respect to an axis of the main body;
a second pair of flutes formed on opposite sides of the main body and extending continuously from the point to the shank portion, wherein each of the second pair of flutes defines a helical cutting edge having a helix angle of approximately 33 degrees with respect to the axis of the main body; and
wherein the first and second pairs of flutes are interleaved.

2. The rotary cutting tool as recited in claim 1, wherein the rotary cutting tool is an end cutting mill.

3. The rotary cutting tool as recited in claim 1, further comprising;
a first pair of flat cutting edges positioned on opposite sides of the main body at the point;
a second pair of flat cutting edges positioned on opposite sides of the main body at the point; and
wherein the first and second pairs of flat cutting edges are interleaved.

4. The rotary cutting tool as recited in claim 3, wherein each of the first pair of flutes extends continuously from a different one of the first pair of flat cutting edges to the shank portion, and wherein each of the second pair of flutes extends continuously from a different one of the second pair of flat cutting edges to the shank portion.

5. The rotary cutting tool as recited in claim 3, wherein the first and second pairs of flat cutting edges are arranged such that an angle of about 83.5 degrees exists between a leading edge of one of the first pair of flat cutting edges and a leading edge of an adjacent one of the second pair of flat cutting edges.

6. The rotary cutting tool as recited in claim 3, wherein the rotary cutting tool comprises a metal, and wherein the helical cutting edges defined by the first and second pair of flutes, and the first and second pairs of flat cutting edges, are coated with a wear reducing material.

7. A rotary cutting tool, comprising:
a substantially cylindrical main body having a shank portion at one end and a point at an opposite end;
a first pair and a second pair of flat cutting edges positioned on opposite sides of the main body at the point, wherein the first and second pairs of flat cutting edges are interleaved;
a first pair of flutes formed on opposite sides of the main body, wherein each of the first pair of flutes extends continuously from the from a different one of the first pair of flat cutting edges to the shank portion and defines a helical cutting edge having a helix angle of about 37 degrees with respect to an axis of the main body; and
a second pair of flutes formed on opposite sides of the main body, wherein each of the second pair of flutes extends continuously from the from a different one of the second pair of flat cutting edges to the shank portion and defines a helical cutting edge having a helix angle of approximately 33 degrees with respect to the axis of the main body.

8. The rotary cutting tool as recited in claim 7, wherein the rotary cutting tool is an end cutting mill.

9. The rotary cutting tool as recited in claim 7, wherein the first and second pairs of flat cutting edges are arranged such that an angle of about 83.5 degrees exists between a leading edge of one of the first pair of flat cutting edges and a leading edge of an adjacent one of the second pair of flat cutting edges.

10. The rotary cutting tool as recited in claim 7, wherein the rotary cutting tool comprises a metal, and wherein the helical cutting edges defined by the first and second pair of flutes, and the first and second pairs of flat cutting edges, are coated with a wear reducing material.
